(19) United States
(12) Patent Application Publication
(10) Pub. No.: US 2009/0250672 A1
(43) Pub. Date: Oct. 8, 2009

(54) Lifting Cart

(76) Inventor: Chi-Ting LIN, Changhua (TW)

Correspondence Address: Dr. BANGER SHIA, 102 Lindencrest Ct., Sugar Land, TX, 77479-5201, US

(21) Appl. No.: 12/062,484

(22) Filed: Apr. 3, 2008

(51) Int. Cl. B66F 9/22; F16M 11/38

(52) U.S. Cl. 254/2 C; 248/647

(57) ABSTRACT

A lift cart is used for car engine maintenance and comprises a moving base for mounting an oil pressure lifting device. One end of the oil pressure lifting device is provided with a platform having a rotatable adjusting device which is adjustable back and forth. The adjusting device is provided with a supporting plate, and a plurality of carrying structures for carrying different sized engine is positioned on the supporting plate. Such arrangements allow the maintenance man to make the height, back and forth, and rotation angle adjustment during disassembly of the engine.

### BACKGROUND OF THE INVENTION

1. Field of the Invention

The present invention relates to a lift cart used for car engine maintenance, and more particularly to a lift cart which can be adjusted in height, position, and rotation angle during disassembly of the engine.

2. Description of the Prior Art

A cart with a lift structure disclosed in TW Pat. serial number 087207581 is a hand truck which can be lifted for carrying goods, which comprises a base, a connecting rod, a carrying rack, two follower rods, an extension rod and a driving rod. The base is a L-shaped structure the front end of which is lower than the rear end, and the carrying rack is mounted on the base for carrying goods. The follower rods, the extension rod and the driving rod are used as a lever to push the carrying rack to pivot forward into a lifting mode or to discharge the goods. However, such a cart can only be used to carry ordinary goods and the height to which the goods can be lifted is very limited, so it is inconvenient to use.

Hence, another improved lift cart with oil pressure is disclosed in TW Pat. serial number 088204057, wherein a rack of the cart is provided with an oil cylinder for lifting a working platform, and an end of the rack is provided with an oil circuit board and is connected to an oil tank. A protruding ear at an end surface of the oil circuit board is pivotally connected to a board frame, and the board frame is provided with a pedal lever for treading. Thereby, a pressing rod transversely provided at a bottom thereof will press an extension rod of a pump, which allows the pump to cooperate with the inlet and outlet oil circuits of the oil circuit board to push the hydraulic oil from the oil tank to the oil cylinder, thus lifting the platform. Such a lift cart can lift the platform, but when in use, the goods are likely to be fallen of due to shake. As a result, the goods are likely to be broken and the maintenance man is likely to be injured. Therefore, such a lift cart also needs to be improved.

The present invention has arisen to mitigate and/or obviate the afore-described disadvantages.

### SUMMARY OF THE INVENTION

The primary objective of the present invention is to provide a lift cart which can be adjusted in height, position, and rotation angle during disassembly of the engine.

To achieve the objective of the present invention, the lift cart comprises a moving base for mounting an oil pressure lifting device. One end of the oil pressure lifting device is provided with a platform having a rotatable adjusting device which is adjustable back and forth. The adjusting device comprises a moving block, a turning member and a screw. The moving block is provided for mounting the turning member and the screw, and the turning member allows the maintenance man to make the rotation angle, and back and forth adjustment during the maintenance process. The turning member is provided with a supporting plate, and a plurality of carrying structures for carrying different sized engine is positioned on the supporting plate.

The above-mentioned oil pressure lifting device is connected to the moving base, which allows the maintenance man to make the height adjustment during disassembly of the engine. In addition, the maintenance man can make the back and forth, and rotation angle adjustment during the maintenance of the engine by cooperating with the moving block, the turning member and the screw of the adjusting device.

The second objective of the present invention is to provide a lift cart. Each carrying structure comprises an inserting member, a vibration absorbing member, a jointing member and an anti-slip member, which are integrally formed as one-piece structure. The carrying structure is inserted in the supporting plate, such that the engine placed on the carrying structures is unlikely to be fallen off, so as to achieve the object of high safety of maintenance. The inserting member is made of a hard material, such as steel and iron. The vibration absorbing member is made of a material, such as sponge and plastic. The jointing member is made of the hard material, such as steel and iron. The anti-slip member has a granular surface. The above-mentioned structures of each carrying structure can be integrally formed as one-piece structure. In addition, the carrying structure can be designed to be an inclined or a planar structure.

The present invention wil become more obvious from the following description when taken in connection with the accompanying drawings, which show, for purpose of illustrations only, the preferred embodiments in accordance with the present invention.

### BRIEF DESCRIPTION OF THE DRAWINGS

FIG. 1 is an exploded view of a lift cart in accordance with the present invention;

FIG. 2 is a perspective view of the lift cart in accordance with the present invention;

FIG. 3 is a perspective view of the lift cart in accordance with the present invention; and

FIG. 4 is a cross sectional view of the lift cart in accordance with the present invention.

### DETAILED DESCRIPTION OF THE PREFERRED EMBODIMENTS

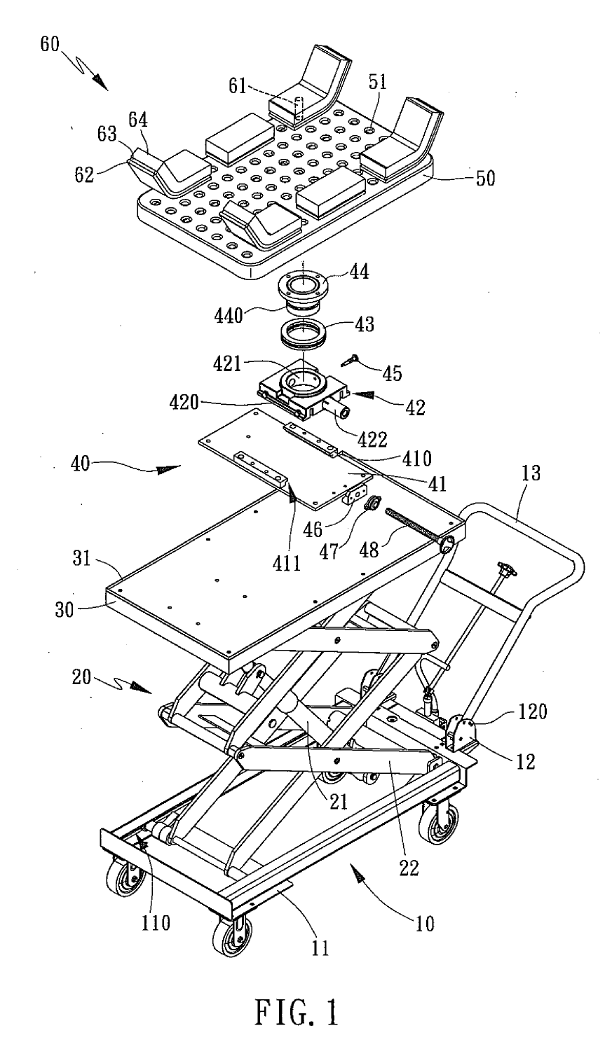

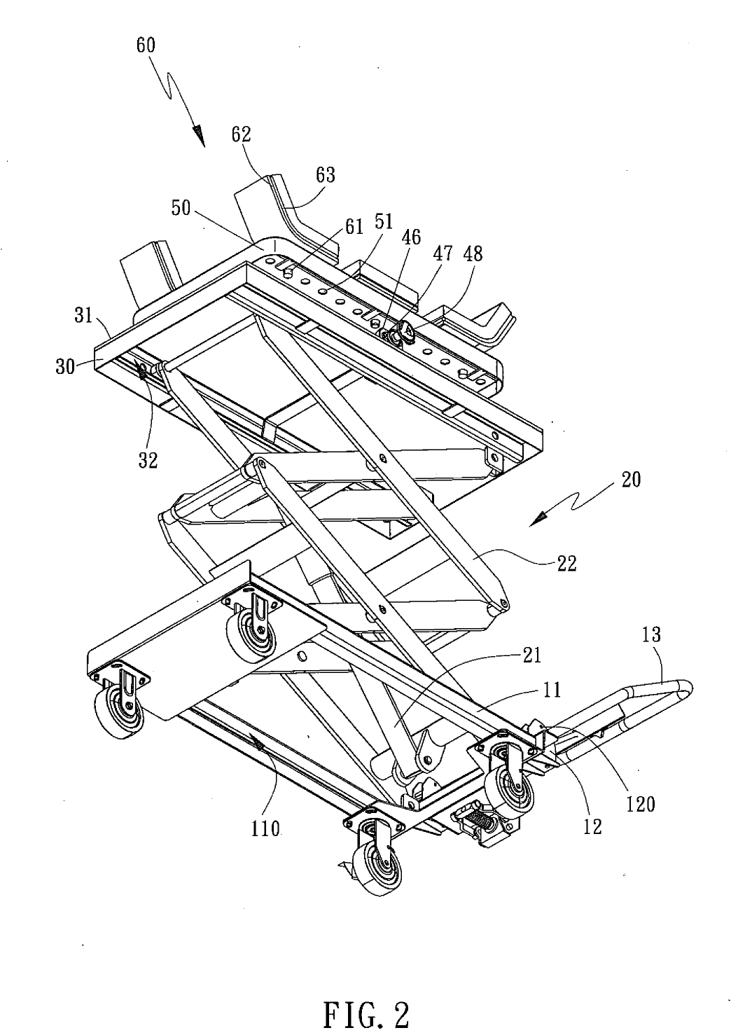

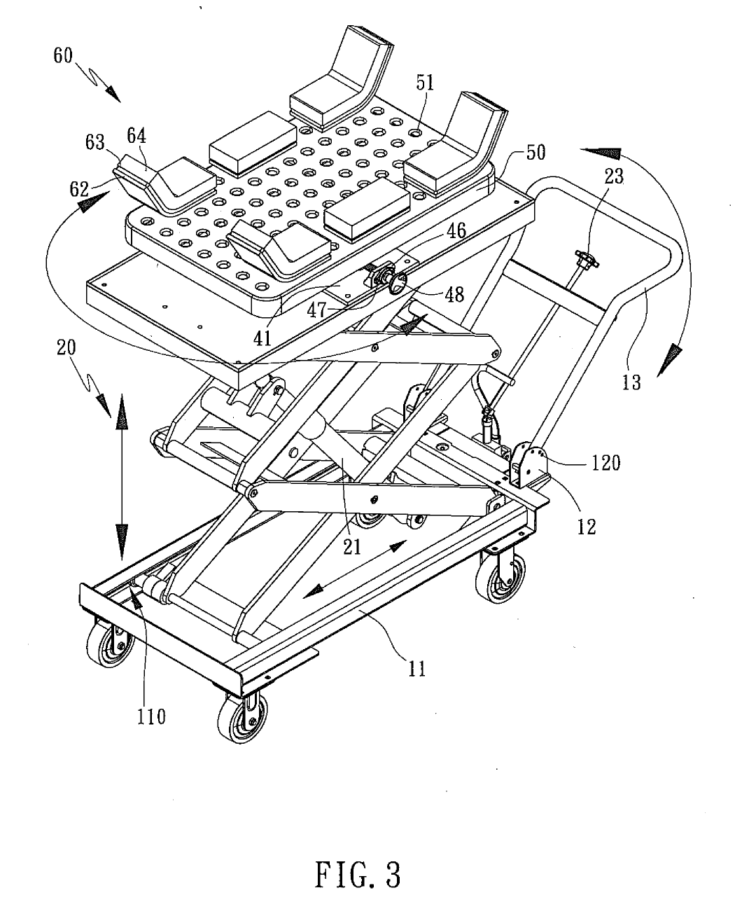

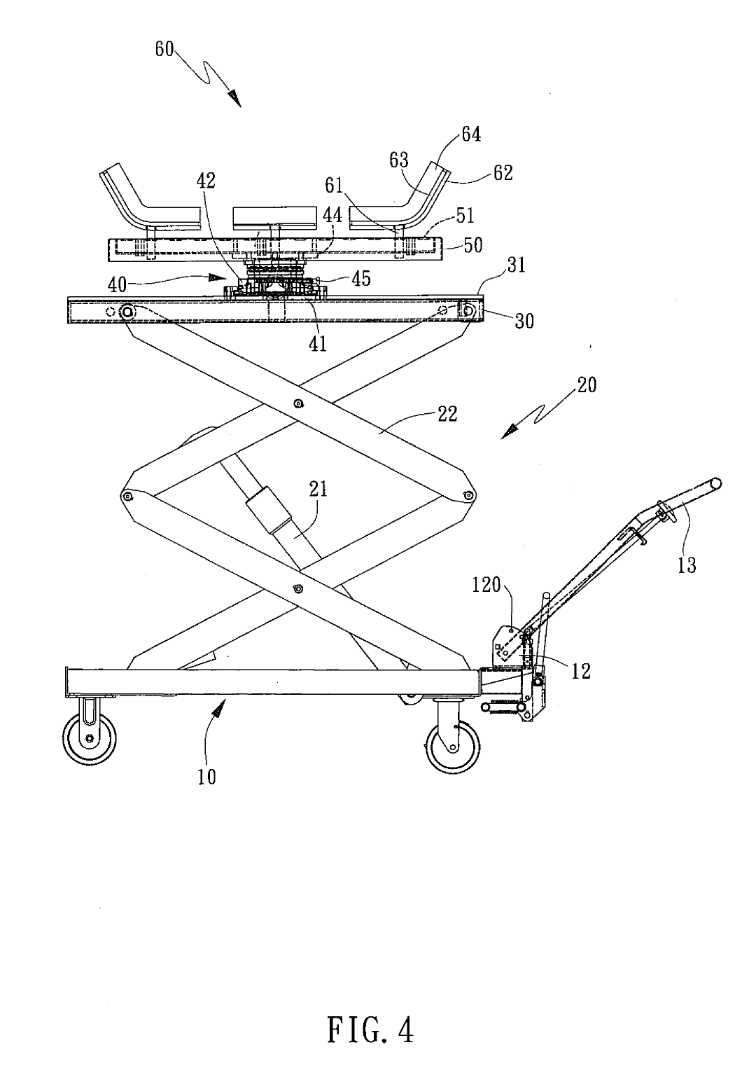

Referring to FIGS. 1-4, a lift cart in accordance with the present invention is used for car engine maintenance and comprises a moving base 10 for mounting an oil pressure lifting device 20. One end of the oil pressure lifting device 20 is provided with a platform 30 having a rotatable adjusting device 40 which is adjustable back and forth. The adjusting device 40 is provided with a supporting plate 50, and a plurality of carrying structures 60 for carrying different sized engine is positioned on the supporting plate 50. Such arrangements allow the maintenance man to make the height, back and forth, and rotation angle adjustment during disassembly of the engine.

The moving base 10 comprises a rectangular frame 11. Both long sides of the frame 1 are defined with a first sliding groove 110, respectively, and both ends of one of the short sides of the frame 1 are provided with a U-shaped supporting seat 12. Both sides of each supporting seat 12 are defined with a plurality of penetrated positioning holes 120, and both ends of a U-shaped handle 13 which is made of a bended tube having a circular cross section are inserted in the supporting seats 12.

The oil pressure lifting device 20 comprises an oil cylinder 21, a plurality of crossed lifting rods 2 and components 23 for controlling the rise and fall motion, and all these members of the oil pressure lifting device 20 are pivotally connected. The oil cylinder 21, the lifting rods 2 and the components 23 for controlling the rise and fall motion are of conventional technique and wil not be described in detail. One end of the oil pressure lifting device 20 is slidably disposed in the first sliding grooves 110 of the frame 1 of the moving base 10, and the other end of the oil pressure lifting device 20 is connected to the platform 30.

The platform 30 is a rectangular block. A sheet-shaped blocking portion 31 is extended upward from the periphery of the top surface of the platform 30, and both long sides of the platform 30 are defined with a second sliding groove 32 in which the other end of the oil pressure lifting device 20 is slidably disposed.

The adjusting device 40 comprises a rectangular positioning board 41 positioned on the platform 30. Both long sides of the positioning board 41 are provided with a L-shaped sliding blocks 410, respectively. Each of the sliding blocks 410 is provided with a sliding portion 41 in which a rectangular moving block 42 is slidably disposed.

The moving block 42 is provided with a moving portion 420 corresponding to the sliding portions 411, and in a center of the moving block 42 is formed an inserting portion 421 in the shape of a hollow cylinder. One end of the moving block 42 vertical to the moving portion 420 is provided with a threaded portion 42 in the shape of a hollow cylinder. A thrust bearing 43 is mounted in the inserting portion 421, and a turning member 4 is mounted in the thrust bearing 43.

One side of the moving block 42 is provided with a column-shaped positioning member 45 which allows the maintenance man to position or turn the turning member 44.

One of the short sides of the positioning board 41 is fixed with a rectangular positioning block 46 for cooperating with a diamond-shaped threaded member 47 which has inner threads. A screw 48 having a turning disc is screwed through the threaded member 47 and into the threaded portion 42 of the moving block 42. The screw 48 is fixed by the positioning block 46 and serves to move the moving block 42.

The supporting plate 50 is a rectangular board and is disposed on the turning member 4 of the adjusting device 40. The supporting plate 50 is defined with a plurality of transverse and longitudinal positioning holes 51 for insertion of the carrying structures 60.

Each carrying structure 60 is provided, in order, with a column-shaped inserting member 61, a rectangular vibration absorbing member 62, a rectangular jointing member 63 and an anti-slip member 64 has a certain thickness. The inserting member 61 is made of a hard material, such as steel and iron. The vibration absorbing member 62 is made of a material, such as sponge, rubber and plastic. The jointing member 63 is made of the hard material, such as steel and iron. The anti-slip member 64 has a granular surface. The above-mentioned structures of each carrying structure 60 can be integrally formed as one-piece structure. In addition, the carrying structure 60 can be designed to be an inclined or a planar structure.

The first feature of the present invention is that one end of the oil pressure lifting device 20 is slidably disposed in the first sliding grooves 110 of the moving base 10, and the other end of the oil pressure lifting device 20 is slidably disposed in the second sliding grooves 32 of the platform 30, such that during the rise and fall motion of the oil pressure lifting device 20, the lifting mechanism 2 can be prevented from disengaging from the frame 1 of the moving base 10, so as to ensure the safety of the maintenance man.

The second feature of the present invention is that both ends of the handle 13 are pivotally disposed in the supporting seats 12, and the positioning holes 120 of the supporting seats 12 allow the maintenance man to position the handle 13 at different angles, which facilitates the maintenance man to push and pull the moving base 10.

The third feature of the present invention is that the blocking portion 31 of the platform 30 can prevent the greasy dirt from accumulating on the platform 30 during the maintenance and cleaning processes, so that the present invention can provide a clean maintenance environment and is convenient to clean.

The fourth feature of the present invention is that the screw 48 of the adjusting device 40 makes the moving block 42 move forward and backward, and at the same time, the moving block 42 moves the turning member 4 and the supporting plate 50 disposed on the turning member 44, thus allowing the maintenance man to make a small amount of back and forth adjustment according to the position of the engine during the maintenance process.

The fifth feature of the present invention is that the turning member 4 mounted in the moving block 42 cooperates the thrust bearing 43 to rotate, which allows the maintenance man to adjust the carrying structures 60 positioned on the supporting plate 50 according to the rotation angle of the engine. After the adjustment is done, the positioning member 45 is used to position the turning member 44.

The sixth feature of the present invention is that the carrying structures 60 can be adjusted according to different sized engine, and when the engine is placed on the carrying structures 60, the anti-slip member 64 prevents the engine from falling of during disassembly and maintenance processes, or the vibration absorbing member 62 can provide a buffering effect when the cart shakes during movement, so as to achieve the object of high safety of maintenance.

While we have shown and described various embodiments in accordance with the present invention, it should be clear to those skilled in the art that further embodiments may be made without departing from the scope of the present invention.

What is claimed is:

1. A lift cart, comprising:
a moving base;
an oil pressure lifting device disposed on a frame of the moving base;
a platform mounted on the oil pressure lifting device;
an adjusting device mounted on the platform and provided with two opposite L-shaped sliding blocks, each of the sliding blocks being provided with a sliding portion in which a moving block being slidably disposed, the moving block being provided with a moving portion corresponding to the sliding portions of the sliding blocks, in a center of the moving block being formed an inserting portion, a thrust bearing being mounted in the inserting portion, a turning member being mounted in the thrust bearing, one end of the moving block vertical to the moving portion being provided with a threaded portion for mounting a screw having a turning disc, the screw being screwed through a threaded member into the threaded portion of the moving block, the screw serving to move the moving block; and
a supporting plate disposed on the turning member of the adjusting device.

2. A lift cart, comprising:
a moving base;
an oil pressure lifting device disposed on the moving base;
a platform mounted on the oil pressure lifting device;
an adjusting device having a positioning board positioned on the platform, both long sides of the positioning board being provided with a sliding block, respectively, each of the sliding blocks being provided with a sliding portion in which a moving block being slidably disposed, the moving block being provided with a moving portion corresponding to the sliding portions of the sliding blocks, in a center of the moving block being formed an inserting portion, one end of the moving block vertical to the moving portion being provided with a threaded portion, a thrust bearing being mounted in the inserting portion, a turning member being mounted in the thrust bearing, one of short sides of the positioning board being provided with a screw having a turning disc, the screw making the moving block move forward and backward;
a supporting plate disposed on the turning member of the adjusting device, and defined with a plurality of positioning holes; and
a plurality of carrying structures inserted in the positioning holes of the supporting plate, each carrying structure being provided, in order, with an inserting member, a vibration absorbing member, a jointing member and an anti-slip member, the inserting member of each carrying structure being inserted in the positioning hole of the supporting plate.

3. The lift cart as claimed in claim 2, wherein the moving base comprises a frame, both long sides of the frame are defined with a first sliding groove, respectively, both ends of one of short sides of the frame are provided with a supporting seat, both sides of each supporting seat are defined with a plurality of penetrated positioning holes, both ends of a U-shaped handle are inserted in the supporting seats, and the positioning holes at both sides of the supporting seats are provided for positioning the handle at different angles.

4. The lift cart as claimed in claim 2, wherein the oil pressure lifting device comprises an oil cylinder, a plurality of crossed lifting rods and components for controlling the rise and fall motion, one end of the oil pressure lifting device is slidably disposed in first sliding grooves of a frame of the moving base, and the other end of the oil pressure lifting device is connected to the platform.

5. The lift cart as claimed in claim 2, wherein a blocking portion is extended upward from a periphery of a top surface of the platform, and both long sides of the platform are defined with a second sliding groove in which another end of the oil pressure lifting device is slidably disposed.

6. The lift cart as claimed in claim 2, wherein one of the short sides of the positioning board is fixed with a positioning block for cooperating with a threaded member, the screw is screwed through the threaded member into the threaded portion of the moving block, and the screw is fixed by the positioning block and serves to move the moving block.

7. The lift cart as claimed in claim 2, wherein the supporting plate is defined with the plurality of transverse and longitudinal positioning holes for insertion of the plurality of carrying structures.

8. The lift cart as claimed in claim 2, wherein the inserting member of each carrying structure is made of a hard material which is selected from the group consisting of steel and iron, the vibration absorbing member of each carrying structure is made of a material which is selected from the group consisting of sponge and plastic, the jointing member of each carrying structure is made of the hard material which is selected from the group consisting of steel and iron, and the anti-slip member of each carrying structure has a granular surface.

9. The lift cart as claimed in claim 2, wherein the inserting member, the vibration absorbing member, the jointing member and the anti-slip member of each carrying structure are designed to be an inclined and a planar structure.

10. A lift cart, comprising:
a moving base;
a platform mounted on the moving base;
an adjusting device mounted on the platform and provided with two opposite L-shaped sliding blocks, each of the sliding blocks being provided with a sliding portion in which a moving block being slidably disposed, the moving block being provided with a moving portion corresponding to the sliding portions of the sliding blocks, in a center of the moving block being formed an inserting portion, a thrust bearing being mounted in the inserting portion, a turning member being mounted in the thrust bearing, one end of the moving block vertical to the moving portion being provided with a threaded portion for mounting a screw having a turning disc, the screw being screwed through a threaded member into the threaded portion of the moving block, the screw serving to move the moving block;
a supporting plate disposed on the turning member of the adjusting device, and defined with a plurality of transverse and longitudinal positioning holes; and
a plurality of carrying structures inserted in the positioning holes of the supporting plate, each carrying structure being provided, in order, with an inserting member, a vibration absorbing member, a jointing member and an anti-slip member, the inserting member of each carrying structure being inserted in the positioning hole of the supporting plate.

11. The lift cart as claimed in claim 10, wherein the moving base comprises a frame, both long sides of the frame are defined with a first sliding groove, respectively, both ends of one of short sides of the frame are provided with a supporting seat, both sides of each supporting seat are defined with a plurality of penetrated positioning holes, both ends of a U-shaped handle are inserted in the supporting seats, and the positioning holes at both sides of the supporting seats are provided for positioning the handle at different angles.

12. The lift cart as claimed in claim 10, wherein a blocking portion is extended upward from a periphery of a top surface of the platform, and one end of the platform is mounted on a frame of the moving base.

13. The lift cart as claimed in claim 10, wherein the adjusting device comprises a positioning board positioned on the platform, both long sides of the positioning board are provided with a sliding block, respectively, each of the sliding blocks is provided with the sliding portion in which the moving block is slidably disposed;
one of short sides of the positioning board is fixed with a positioning block for cooperating with the threaded member, the screw is screwed through the threaded member into the threaded portion of the moving block, and the screw is fixed by the positioning block and serves to move the moving block.

14. The lift cart as claimed in claim 10, wherein the supporting board is a rectangular board and is disposed on the turning member of the adjusting device, the supporting plate is defined with the plurality of transverse and longitudinal positioning holes for insertion of the carrying structures.

15. The lift cart as claimed in claim 10, wherein the inserting member of each carrying structure is made of a hard material which is selected from the group consisting of steel and iron, the vibration absorbing member of each carrying structure is made of a material which is selected from the group consisting of sponge and plastic, the jointing member of each carrying structure is made of the hard material which is selected from the group consisting of steel and iron, and the anti-slip member of each carrying structure has a granular surface.

16. The lift cart as claimed in claim 10, wherein the inserting member, the vibration absorbing member, the jointing member and the anti-slip member of each carrying structure are designed to be an inclined and a planar structure.
